(19) United States
(12) Patent Application Publication
(10) Pub. No.: US 2014/0258132 A1
(43) Pub. Date: Sep. 11, 2014

(54) SYSTEM AND METHOD FOR SECURE ELECTRONIC TRANSACTION

(71) Applicant: EZETAP MOBILE SOLUTIONS PRIVATE LIMITED, BANGALORE (IN)

(72) Inventors: Sanjay Swamy, Bangalore (IN); Bhaktha Ram Keshavachar, Bangalore (IN)

(73) Assignee: EZETAP MOBILE SOLUTIONS PRIVATE LIMITED, BANGALORE (IN)

(21) Appl. No.: 14/349,150

(22) PCT Filed: Sep. 28, 2012
(86) PCT No.: PCT/IN2012/000649

§ 371 Date: Apr. 28, 2014

(30) Foreign Application Priority Data
Oct. 3, 2011 (IN) 3415/CHE/2011

(51) Int. Cl. G06Q 20/40; G06Q 20/38

(52) U.S. Cl. CPC G06Q 20/409; G06Q 20/3829; G06Q 20/4012; G06Q 2220/00
USPC 705/67

(57) ABSTRACT

The various embodiments herein provide a system for a secure electronic transaction. The system comprises a dongle connected to a computing device for reading an electronic card data, a client application running on the client device for collecting a transaction information from a customer, a service provider system connected to the computing device through a first communication network for transmitting the collected transaction information and the audio signal from the computing device to the service provider system, a production server located at the service provider system for processing the received card data, a payment server for processing the audio signal, a second communication network for transmitting a processed card data from the production server to a payment system and a payment gateway running on the payment system for interfacing with the service provider system. The payment system performs the financial transaction by authenticating the customer and a merchant.

### CROSS REFERENCE TO RELATED APPLICATION

The present application is a national phase application to the PCT Application entitled, “SYSTEM AND METHOD FOR SECURE ELECTRONIC TRANSACTION” with serial number PCT/IN2012/000649, filed at Government of India Patent Office on Sep. 28, 2012, the content of which is incorporated by reference herein.

The present application claims the benefit of an Indian Provisional Patent Application entitled, “SYSTEM AND METHOD FOR SECURE ELECTRONIC TRANSACTION” with serial number 3415/CHE/2011, filed at Government of India Patent Office on Oct. 3, 2011, the content of which is incorporated by reference herein.

### BACKGROUND

1. Technical Field

The embodiments herein generally relate to a field of electronic transaction. The embodiments herein particularly relate to a system and method for secure electronic transaction. The embodiments herein more particularly relate to a system and method for secure electronic transaction using a dongle device.

2. Description of the Related Art

Currently, there are hundreds of magnetic stripe readers/swipers on the market; all of them are at least as long as the credit card itself. There exist different types of card readers/swipers. One type is traditional card swiper with single rails, which allow a card to be held against the base of the reader by the user and moved across the read head of the reader. Another type of card reader guides a card by two sets of rails and a backstop. Once the user has inserted the card against the backstop, the card is read as it is removed from the swiper. Magnetic stripe cards having standard specifications can typically be read by the point-of-sale devices at a merchant's location. When the card is swiped through an electronic card reader at the checkout counter at a merchant's store, the reader usually uses its built-in modem to dial the number of a company that handles credit authentication requests. After the account is verified, an approval signal is sent back to the merchant to complete a transaction.

The conventional swipe device using magnetic card readers for electronic payment is bulky. Further the merchant has to produce the printed receipts for the customer, which is very cumbersome for the merchant handling multiple customers. And also the merchant has to keep record of all the printed receipts, to avoid the dispute about the transactions. It is advantageous for an individual to make a payment to another individual or merchant by swiping his magnetic stripe card through a reader connected to a mobile device.

Hence there were huge developments in providing the card reader for a mobile phone. In the currently available systems, providing portable swipe machine for mobile devices, the card data is encrypted on the mobile phone. Hence there is a chance of insecure transaction over the mobile phone. Further, the existing systems communicate the relevant data through the electrical signals, which are extremely slow compared to the electromagnetic signals. In the current scenario, the communication is always performed on IP network, since IP networks are wide spread. Further the existing devices work only with high end devices such as iPhone, iPad or any other smart phone, making the system very costly for the prospective users. Further the swipe machines used presently are active devices, where machines need to be charged with an external power supply or through a connected device.

In view of the above facts, there is a need for a secure electronic transaction. There is also a need for a system and method providing a secure electronic transaction in a cost effective manner. Further there is a need for a system and method to provide to perform electronic transaction in a fast and efficient manner. Yet there is a need for a system and method to utilize the fast and efficient IP communication, thereby reducing the need for the use of electrical signal.

The above mentioned shortcomings, disadvantages and problems are addressed herein and which will be understood by reading and studying the following specification.

### OBJECTS OF THE EMBODIMENTS

The primary object of the embodiments herein is to provide a system and method for a secure electronic transaction.

Another object of the embodiments herein is to provide a dongle to connect to a computing device to perform an electronic transaction

Yet another object of the embodiments herein is to provide a system and method to enable a fast and efficient electronic transaction.

Yet another objective of the embodiments herein is to provide a portable swipe machine or dongle for all the users wishing to do an electronic transaction.

Yet another object of the embodiments herein is to provide a system and method for secure electronic transaction by machine level encryption of a data.

Yet another object of the embodiments herein is to provide a cost effective swipe machine for a computing device.

Yet another object of the embodiments herein is to provide a system and method for electronic transaction in which power consumed by the system is managed efficiently.

Yet another object of the embodiments herein is to provide a system and method for electronic transaction with a compression scheme to save the memory of the system.

Yet another object of the embodiments herein is to provide a system and method for electronic transaction with a compression scheme that runs on an open device such as mobile device.

Yet another objective of the embodiments herein is to provide a user interface for a computing device to perform an electronic transaction.

Yet another object of the embodiments herein is to provide a way to transform card data into a token data and to transmit the token data without sending the card data from a computing device to a server.

Yet another object of the embodiments herein is to provide a method to safely enter a PIN on a computing device using a scrambled keypad method.

Yet another objet of the embodiments herein is to provide a keypad on the dongle to prevent tampering of keypad of the computing device.

Yet another object of the embodiments herein is to prevent a replay attack in an electronic transaction.

Yet another object of the embodiments herein is to provide a security mechanism to perform an electronic transaction.

These and other objects and advantages of the embodiments herein will become readily apparent from the following detailed description taken in conjunction with the accompanying drawings.

### SUMMARY

According to the various embodiments herein, a system and method for secure electronic transaction is provided. The system for a secure electronic transaction comprising a dongle connected to a computing device for reading an electronic card data, a client application running on the client device for collecting a transaction information from a customer, a service provider system connected to the computing device through a first communication network for transmitting the collected transaction information and the audio signal from the computing device to the service provider system, a production server located at the service provider system for processing the received card data, a payment server for processing the audio signal, a second communication network for transmitting a processed card data from the production server to a payment system and a payment gateway running on the payment system for interfacing with the service provider system. The payment system performs the financial transaction by authenticating the customer and a merchant.

According to an embodiment herein, the dongle comprises a magnetic card reader for reading a swipe data, a key pad for entering a PIN data, a microchip for decoding, tokenizing, transforming, encrypting, modulating and representing a swipe data and PIN data as an audio signal, a flash, a battery for a power supply and a retractable connecting plug. The swipe data is in the form of analog signals and is a unique data for the electronic card.

According to an embodiment herein, the retractable connecting plug connects the dongle to the computing device through a connecting port such as audio jack or a mini USB.

According to an embodiment herein, the flash stores a dongle ID, a serial number of the dongle and a public key. The dongle ID and the serial number of the dongle are paired at a time of manufacturing the dongle.

According to an embodiment herein, the client application provides a scrambled keypad for preventing an onlooker from detecting a personal identification number (PIN) entered by the customer. According to an embodiment herein, the PIN is any one of a scrambled PIN data or a PIN block or a one time password.

According to an embodiment herein, the first communication network is an IP network.

According to an embodiment herein, the production server comprises a gateway server for interfacing the client application and the production server, a payment database for storing information about the dongle, an analytics database. The analytics database stores a metadata, a frequency of a plurality of swipes for the electronic card, a plurality of fraud patterns and a plurality of customer spend patterns.

According to an embodiment herein, the gateway server conducts an authentication, firewalling and load balancing operations,

According to an embodiment herein, the payment server comprises a decoder for decoding the audio signal, a decryption engine loaded with a decryption algorithm for converting a cipher text to a normal text using a private key. The private key is generated randomly by the payment server using a global unique identification (GUID) number and wherein the GUID is generated at the payment server based on the paired dongle ID and the serial number of the dongle.

According to an embodiment herein, the second communication network is an IP network.

According to an embodiment herein, the payment gateway interfaces a plurality of financial institutions to complete a financial transaction.

According to an embodiment herein, the microchip comprises a counter for keeping a track on a status of a swipe such as a good swipe or a bad swipe, a comparator for performing a frequency/double frequency (F2F) decoding and a post-processing of the swipe data to increase a probability of a good swipe, a converter for converting the swipe data into a card data, a memory unit for storing the card data, a tokenizer for converting the card data into a token data using a standard mathematical transformation, an encryption engine loaded with an encryption algorithm for encrypting the token data using a PKI (Public Key Infrastructure) asymmetric algorithm such as 1024 bit RSA algorithm, 2048 bit RSA algorithm, a modulation engine for modulating the token data, a low pass filter for filtering the token data, a voltage divider network for representing the token data as audio signal, a random number generator for avoiding replay attacks and an ADC (Analog to Digital Converter) for measuring a voltage level of the battery.

According to an embodiment herein, the audio signal is an audio tone signal.

According to an embodiment herein, wherein the dongle ID is a unique and secret ID associated with the dongle.

According to an embodiment herein, the public key is used in RSA algorithm for encrypting the card data.

According to an embodiment herein, wherein the information about the dongle includes at least one of a Global Universal Identification (GUID) associated with the dongle, a serial number of the dongle and a merchant's personal information provided at the time of registration.

According to an embodiment herein, the dongle further includes a keypad for reading a PIN entered by the card holder.

According to an embodiment herein, the card is one of a magnetic card, a Near Field Communication (NFC) card, a smart card.

According to an embodiment herein, the computing device is one of a cell phone, an Apple's iPhone, an iPod, an iPad, an iTouch, a Google's Android device and a general purpose computer.

According to an embodiment herein, the swipe data is recorded at a first swipe to avoid a replay attack.

According to an embodiment herein, the swipe data is sent alone as an audio signal after tokenization and encryption.

According to an embodiment herein, the dongle is powered by swiping a magnetic card, inserting a smart card, waving a NFC card. The power is produced by one of a micro-switch, a low power amplifier or a comparator, a switch in the audio jack, a sensitive microphone, a photo detector having a solar cell and a mic bias.

According to an embodiment herein, the transaction information includes an amount of the transaction, an unique PIN of the card entered by the card holder, an additional data related to the transaction, and a signature of a card holder.

According to an embodiment herein, the client application provides a graphical user interface (GUI) for a user to interact with the system.

According to an embodiment, the client application includes a compression scheme for compressing the token data.

According to an embodiment herein, the dongle is a tamperproof device and wherein a circuit board in the dongle is impregnated with resin to provide a tamper proof property and a microprocessor based security fuse is provided in the dongle to provide a tamperproof property so that the security fuse is blown at a time of manufacturing the dongle.

According to an embodiment herein, the system provides a user login based Virtual point of sales (POS) system. The virtual POS is provided by using different accounts in the computing device to act as different merchants.

According to an embodiment herein, the dongle of the embodiments herein further comprises a public key. The public key is burned on the dongle at a manufacture time.

According to an embodiment herein, the system provides a user login based Virtual point of sales (POS) system, wherein the virtual POS is provided by using different accounts in the computing device to act as different merchants.

According to an embodiment herein, the dongle further comprises a public key burned at a time of manufacture the dongle.

According to an embodiment herein, the dongle generates a session key and a secret key at a beginning of the transaction, and wherein the secret key is used for authenticating the payment server, and wherein the session key and secret key are encrypted by the public key before sending to the payment server.

According to an embodiment herein, the payment server further comprises a private key, and wherein the private key decrypts the secret key sent by the dongle and sends back the decrypted secret key to the dongle for mutually authenticating the dongle and the payment server.

According to an embodiment herein, the dongle is injected with a plurality of keys, and wherein the plurality of keys is a banking domain key and an acquirer key.

According to an embodiment herein, the server is provided with a plurality of keys, and wherein the plurality of keys is a banking domain key and an acquirer key.

According to an embodiment herein, the banking key or the acquirer key is selected based on a card issuer.

According to an embodiment herein, the banking key or the acquirer key is selected from the dongle based on a business intelligence (BI) rule and wherein the BI rule is set on the dongle using a user interface on a mobile phone and wherein the BI rule is set on the dongle using a server.

According to an embodiment herein, a PIN is encrypted in the dongle selected using the session key.

According to an embodiment herein, the PIN is translated into a banking domain key using a secure device and wherein the secure device is HSM device.

According to an embodiment herein, the banking key or the acquirer key is selected from the server based on a BIN number or a business intelligence (BI) rule.

According to an embodiment herein, the BIN number or the BI rule is set on the dongle by a merchant using a user interface on a mobile phone and wherein the BIN number or the BI rule is set on the dongle by a merchant using a user interface on a portal.

According to an embodiment herein, the dongle further comprises a NFC tag, and wherein the NFC tag of the dongle includes a unique ID and a physical unclonable function (PUF).

According to an embodiment herein, the merchant device comprises a NFC tag, and wherein the NFC tag of the merchant device authenticates the dongle by verifying the unique ID of the dongle NFC tag.

According to an embodiment herein, in case of a key compromise in the server, new public keys are programmed into the dongle over a secure communication link. The link can be in a secure location or over the air as determined by the business needs of the acquirer. The acquirer keys are injected into the dongle in a secure location or over the air using the secure link establishment. The dongles are authenticated by verifying their serial numbers and the secret IDs against a positive database in the server. The selection of the key is either based on the BIN (the first 6 digits of the card) or on a command set by the phone/server to the dongle.

According to an embodiment herein, the PIN entered by the user on the secure keyboard is encrypted by the chosen acquirer key using industry standard algorithms like 3-DES and a PIN block is generated and sent to the acquirer. The key for encryption is either a unique key per terminal (UKPT) given by the acquirer or a derived key from a master key (DUKPT).

According to an embodiment herein, the dongle comprises a secret ID and a publicly visible serial number. The secret ID and publicly visible serial numbers are paired at manufacture time and are stored in the database securely. Later the stored details of the secret ID and publicly visible serial numbers are transported to the server. Whenever a dongle needs to transact with the server it establishes a secure connection to the server. The server authenticates a dongle by checking the serial number and the secret dongle ID on a positive database.

According to an embodiment herein, the dongle generates a session key and a secret key at the beginning of the transaction. The generated secret key is used for authenticating the payment server. The session key and the secret key along with the serial number and unique ID of the dongle are encrypted by the public key before sending to the payment server.

According to an embodiment herein, the payment server comprises a private key. The private key decrypts the secret key sent by the dongle and sends back the decrypted secret key to the dongle for mutually authenticating the dongle and the payment server. The public-private key pair is identified by a key ID at the payment server. After authentication, the communication is done using the session key using a standard encryption algorithm like AES-256.

According to an embodiment herein, the issuer keys are stored in the dongle for encrypting the PIN and generating ISO standard PIN blocks. The management and injection of keys is done as per issuer conforming to the standard industry practices.

According to an embodiment herein, the dongle further comprises a NFC tag. The NFC tag of the dongle includes a unique ID and a physical unclonable function (PUF). The physical unclonable function provides tamper proof for the NFC tag.

According to an embodiment herein, the merchant device comprises a NFC tag. The NFC tag of the merchant device authenticates the dongle by verifying the unique ID of the dongle NFC tag.

According to an embodiment herein, the merchant is authenticated using a user-ID and password. Other forms of authentication like OTP and bio-metric is also used. According to an embodiment herein, the method for a secure electronic transaction comprising the steps of logging in by a merchant into a client application installed on a computing device, swiping a card onto a dongle, tracking a status of a swipe, reading a swipe data by a magnetic card reader of the dongle, extracting a public key burnt on a flash of the dongle, processing the swipe data by a microchip for producing a cipher data, representing the cipher data and a PIN data as an audio signal, transmitting the cipher data and the PIN data to a mobile device through an audio jack of the mobile device, collecting a transaction information through a graphical user interface (GUI), collecting a part of a card number from the merchant, constructing a hash value out of the cipher data by using a hash algorithm of a client application running on a computing device, transmitting the hash value along with the transaction information to a production server through a first communication network, processing the cipher data and the PIN data in a payment server of the production server, sending a transaction request to a third party system to perform an electronic transaction, transmitting a transaction information to the third party system through a second communication network, performing the electronic transaction by the third party system and indicating a transaction status.

According to an embodiment herein, the data communicated between the mobile device and the dongle is in a form of acoustic signals or audio tones.

According to an embodiment herein, the GUI is provided by the client application.

According to an embodiment herein, the hash algorithm is exchanged and stored between the mobile device and the payment server for a first time.

According to an embodiment herein, the transaction status is indicated by an audio tone or a colored light. The transaction status is one of a bad transaction and a good transaction.

According to an embodiment herein, the step processing the swipe data by a microchip for producing a cipher data comprises generating a random number for avoiding a replay attack, decoding the swipe data by a comparator, converting the swipe data into a card data by a converter, tokenization of the card data by a tokenizer by Xoring the card data with a dongle ID, encrypting the card data into a cipher data by an encryption engine using a RSA algorithm and modulating the cipher data by a modulation engine using Frequency Shift Keying (FSK). The dongle ID is a unique and secret ID related to the dongle.

According to an embodiment herein, a public key is used in RSA algorithm for encrypting the card data.

According to an embodiment herein, the step of processing the cipher data in a payment server of the production server comprises decoding the hash value by a decoder of the payment server for producing the cipher data, decrypting the cipher data by a decryption engine of the payment server using a private key, retrieving a merchant information stored in a payment database of the production server, reproducing a complete card number by stitching a part of the card number entered by the merchant with a card data received from the dongle and authenticating the merchant.

According to an embodiment herein, the step of representing the cipher data as an audio signal comprises filtering the cipher data by a low pass filter and dividing a voltage of cipher data for producing amplitude for the audio signal.

According to an embodiment herein, the step of constructing the hash value out of the encrypted data by the hash function of the client application running on the mobile phone is done by creating a date/time stamp.

According to an embodiment herein, the method for secure electronic transaction further comprises sending an electronic receipt to the customer through a short message service (SMS) or an e-mail.

According to an embodiment here, the method for secure electronic transaction further comprises recording a transaction status by a counter of the microchip.

According to an embodiment herein, the method for secure electronic transaction further comprises measuring a voltage level of a battery of the dongle by an analog-to-digital convertor (ADC) of the microprocessor, sending a measured voltage level along with the transaction data to the production server, collating a reading of the battery by the payment server, computing a remaining voltage level in the battery by the payment server and sending an information corresponding to the remaining voltage level in the battery to a user.

According to an embodiment herein, the transaction information includes an amount of the transaction, an unique PIN of the card entered by the card holder, an additional data related to the transaction and a signature of a card holder.

According to an embodiment herein, the PIN is any one of a scrambled PIN data or a PIN block or a onetime password.

According to an embodiment herein, the method for secure electronic transaction further comprises an updating of the public key. Updating of the public key comprises swiping a non financial card on a swipe machine, reading a swipe data by a reader head of the dongle, extracting a public key from the swipe data and updating the public key associated with the dongle.

According to an embodiment herein, the method for secure electronic transaction further comprises mapping a merchant ID, a terminal ID, a user ID, IMEI number of computing device, a serial number of the dongle with a dongle ID for executing a secure electronic transaction.

According to an embodiment herein, the method for secure electronic transaction further comprises mapping a dongle ID, serial number of dongle with IMEI number of a mobile phone for executing a secure electronic transaction.

According to an embodiment herein, the public key is burned in the dongle at a manufacturing time.

According to an embodiment herein, the dongle generates a session key and a secret key at a beginning of the transaction, and wherein the secret key is used for authenticating the payment server, and wherein the session key and secret key are encrypted by the public key and sent to the payment server.

According to an embodiment herein, the payment server further comprises a private key, and wherein the private key decrypts the secret key sent by the dongle and sends back the decrypted secret key to the dongle for mutually authenticating the dongle and the payment server.

According to an embodiment herein, a plurality of keys is injected in the dongle and wherein the plurality of keys is a banking domain key and an acquirer key.

According to an embodiment herein, a plurality of keys is provided with the server and wherein the plurality of keys is a banking domain key and an acquirer key.

According to an embodiment herein, the banking key or the acquirer key is selected based on a card issuer.

According to an embodiment herein, the banking key or the acquirer key is selected from the dongle based on a business intelligence (BI) rule and wherein the BI rule is set on the dongle using a user interface on a mobile phone and wherein the BI rule is set on the dongle using a server.

According to an embodiment herein, a PIN is encrypted in the dongle selected using the session key.

According to an embodiment herein, the PIN is translated into a banking domain key using a secure device and wherein the secure device is HSM device.

According to an embodiment herein, the banking key or the acquirer key is selected from the server based on a BIN number or a business intelligence (BI) rule.

According to an embodiment herein, the BIN number or the BI rule is set on the dongle by a merchant using a user interface on a mobile phone and wherein the BIN number or the BI rule is set on the dongle by a merchant using a user interface on a portal.

According to an embodiment herein, the dongle further comprises a NFC tag, and wherein the NFC tag of the dongle includes a unique ID and a physical unclonable function (PUF).

According to an embodiment herein, the merchant device comprises a NFC tag, and wherein the NFC tag of the merchant device authenticates the dongle by verifying the unique ID of the dongle NFC tag.

According to an embodiment herein, a swipe data alone is sent as an audio signal after tokenization and encryption.

According to an embodiment herein, a method for providing a user friendly secure electronic transaction comprising the steps of providing a Standard Development Kit (SDK) for a merchant to develop a client application and wherein the client application is developed by the merchant according to a requirement; installing the client application on a computing device and executing a plurality of electronic transactions using the computing device.

According to an embodiment herein, the step of executing the plurality of electronic transactions comprises logging in by a merchant into a client application installed on a computing device, swiping a card onto a dongle, tracking a status of a swipe, reading a swipe data by a magnetic card reader of the dongle, extracting a public key burnt on a flash of the dongle, processing the swipe data by a microchip for producing a cipher data, representing the cipher data as an audio signal, transmitting the cipher data to a mobile device through an audio jack of the mobile device, collecting a transaction information through a graphical user interface (GUI), collecting a part of a card number from the merchant, constructing a hash value out of the cipher data by using a hash algorithm of a client application running on a computing device, transmitting the hash value along with the transaction information to a production server through a first communication network, processing the cipher data in a payment server of the production server, sending a transaction request to a third party system to perform an electronic transaction, transmitting a transaction information to the third party system through a second communication network, performing the electronic transaction by the third party system and indicating a transaction status.

According to an embodiment herein, the data communicated between the mobile device and the dongle is in a form of acoustic signals or audio tones.

According to an embodiment herein, the GUI is provided by the client application.

According to an embodiment herein, the hash algorithm is exchanged and stored between the mobile device and the payment server for a first time;

According to an embodiment herein, the transaction status is indicated by an audio tone or a colored light. The transaction status is one of a bad transaction and a good transaction.

According to an embodiment herein, the step processing the swipe data by a microchip for producing a cipher data comprises generating a random number for avoiding a replay attack, decoding the swipe data by a comparator, converting the swipe data into a card data by a converter, tokenization of the card data by a tokenizer by Xoring the card data with a dongle ID, encrypting the card data into a cipher data by an encryption engine using a RSA algorithm and modulating the cipher data by a modulation engine using Frequency Shift Keying (FSK). The dongle ID is a unique and secret ID related to the dongle.

According to an embodiment herein, a public key is used in RSA algorithm for encrypting the card data.

According to an embodiment herein, the step of processing the cipher data in a payment server of the production server comprises decoding the hash value by a decoder of the payment server for producing the cipher data, decrypting the cipher data by a decryption engine of the payment server using a private key, retrieving a merchant information stored in a payment database of the production server, reproducing a complete card number by stitching a part of the card number entered by the merchant with a card data received from the dongle and authenticating the merchant.

According to an embodiment herein, the step of representing the cipher data as an audio signal comprises filtering the cipher data by a low pass filter and dividing a voltage of cipher data for producing amplitude for the audio signal.

According to an embodiment herein, the step of constructing the hash value out of the encrypted data by the hash function of the client application running on the mobile phone is done by creating a date/time stamp.

According to an embodiment herein, the method for secure electronic transaction further comprises sending an electronic receipt to the customer through a short message service (SMS) or an e-mail.

According to an embodiment here, the method for secure electronic transaction further comprises recording a transaction status by a counter of the microchip.

According to an embodiment herein, the method for secure electronic transaction further comprises measuring a voltage level of a battery of the dongle by an analog-to-digital convertor (ADC) of the microprocessor, sending a measured voltage level along with the transaction data to the production server, collating a reading of the battery by the payment server, computing a remaining voltage level in the battery by the payment server and sending an information corresponding to the remaining voltage level in the battery to a user.

According to an embodiment herein, the transaction information includes an amount of the transaction, an unique PIN of the card entered by the card holder, an additional data related to the transaction and a signature of a card holder.

According to an embodiment herein, the PIN is any one of a scrambled PIN data or a PIN block or a onetime password.

According to an embodiment herein, the method for secure electronic transaction further comprises an updating of the public key. Updating of the public key comprises swiping a non financial card on a swipe machine, reading a swipe data by a reader head of the dongle, extracting a public key from the swipe data and updating the public key associated with the dongle.

According to an embodiment herein, the method for secure electronic transaction further comprises mapping a merchant ID, a terminal ID, a user ID, IMEI number of computing device, a serial number of the dongle with a dongle ID for executing a secure electronic transaction.

According to an embodiment herein, the method for secure electronic transaction further comprises mapping a dongle ID, serial number of dongle with IMEI number of a mobile phone for executing a secure electronic transaction.

According to an embodiment herein, the public key is burned in the dongle at a manufacturing time.

According to an embodiment herein, the dongle generates a session key and a secret key at a beginning of the transaction, and wherein the secret key is used for authenticating the payment server, and wherein the session key and secret key are encrypted by the public key and sent to the payment server.

According to an embodiment herein, the payment server further comprises a private key, and wherein the private key decrypts the secret key sent by the dongle and sends back the decrypted secret key to the dongle for mutually authenticating the dongle and the payment server.

According to an embodiment herein, a plurality of keys is injected in the dongle and wherein the plurality of keys is a banking domain key and an acquirer key.

According to an embodiment herein, a plurality of keys is provided with the server and wherein the plurality of keys is a banking domain key and an acquirer key.

According to an embodiment herein, the banking key or the acquirer key is selected based on a card issuer.

According to an embodiment herein, the banking key or the acquirer key is selected from the dongle based on a business intelligence (BI) rule and wherein the BI rule is set on the dongle using a user interface on a mobile phone and wherein the BI rule is set on the dongle using a server.

According to an embodiment herein, a PIN is encrypted in the dongle selected using the session key.

According to an embodiment herein, the PIN is translated into a banking domain key using a secure device and wherein the secure device is HSM device.

According to an embodiment herein, the banking key or the acquirer key is selected from the server based on a BIN number or a business intelligence (BI) rule.

According to an embodiment herein, the BIN number or the BI rule is set on the dongle by a merchant using a user interface on a mobile phone and wherein the BIN number or the BI rule is set on the dongle by a merchant using a user interface on a portal.

According to an embodiment herein, the dongle further comprises a NFC tag, and wherein the NFC tag of the dongle includes a unique ID and a physical unclonable function (PUF).

According to an embodiment herein, the merchant device comprises a NFC tag, and wherein the NFC tag of the merchant device authenticates the dongle by verifying the unique ID of the dongle NFC tag.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a system for secure electronic transaction, according to an embodiment herein.

FIG. 2 illustrates a block circuit diagram of a dongle used in a system for secure electronic transaction, according to an embodiment herein.

FIG. 3 illustrates a flowchart for a method for secure electronic transaction, according to an embodiment herein.

FIG. 4 illustrates a perspective view of a dongle, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

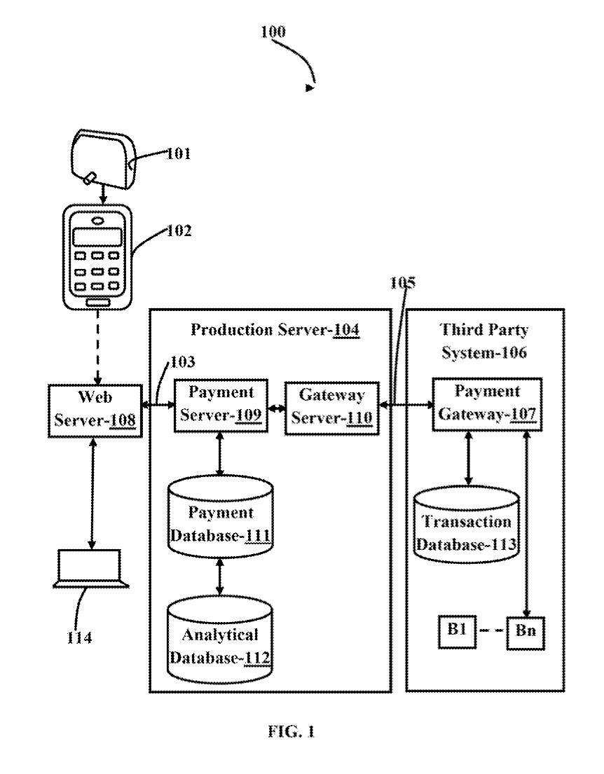

FIG. 1 illustrates a functional block diagram of a system for secure electronic transaction, according to an embodiment herein. The system 100 comprises a dongle 101 connected to a computing device 102 for reading an electronic card data, a client application (not shown in FIG. 1) running on the computing device 102 for collecting a transaction information such as an amount of the transaction, an unique PIN of the card entered by the card holder, an additional data related to the transaction and a signature of a card holder, a service provider system connected to the computing device 102 through a first communication network 103 for transmitting the collected transaction information and the audio signal from the computing device 102 to the service provider system, a production server 104 located at the service provider system for processing the received card data, a second communication network 105 for transmitting a processed card data from the production server 104 to a third party system 106 and a payment gateway 107 running on the third party system 106 for interfacing with the service provider system. The third party system 106 performs the financial transaction by authenticating the customer and a merchant. The first communication network 103 and the second communication network 105 are IP networks connected in turn to a web server 108. The transaction information includes an amount of the transaction, an unique PIN of the card entered by the card holder, an additional data related to the transaction, and a signature of a card holder.

The production server 104 comprises a payment server 109 for processing the audio signal, a gateway server 110 for interfacing the client application and the production server 104, a payment database 111 for storing information about the dongle 101, an analytics database 112. The analytics database 112 stores a metadata, a frequency of a plurality of swipes for the electronic card, a plurality of fraud patterns and a plurality of customer spend patterns. The gateway server 110 conducts an authentication, firewalling and load balancing operations.

The payment gateway 107 interfaces a plurality of financial institutions to complete a financial transaction. The plurality of financial institutes are banks B1 . . . Bn. The payment gateway 107 access a transaction database 113 of the third party system 106 for getting details of the customer.

The system 100 further comprises an admin workstation 114 for monitoring the system 100.

The dongle 101 comprises a magnetic card reader for reading a swipe data, a microchip for decoding, tokenizing, transforming, encrypting, modulating and representing a swipe data as an audio signal, a flash, a battery for a power supply and a retractable connecting plug. The swipe data is in the form of analog signals and is a unique data for the electronic card. The retractable connecting plug connects the dongle to the computing device 102 through a connecting port such as audio jack or a mini USB. The swipe data is recorded at a first swipe.

The flash stores a dongle ID, a serial number of the dongle and a public key. The dongle ID and the serial number of the dongle are paired at a time of manufacturing the dongle. The dongle ID is a unique and secret ID associated with the dongle. The public key is used in RSA algorithm for encrypting the card data.

The client application provides a scrambled keypad for preventing an onlooker from detecting a personal identification number (PIN) entered by the customer.

The payment server 109 comprises a decoder for decoding the audio signal, a decryption engine loaded with a decryption algorithm for converting a cipher text to a normal text using a private key. The private key is generated randomly by the payment server 109 using a global unique identification (GUID) number and wherein the GUID is generated at the payment server 109 based on the paired dongle ID and the serial number of the dongle.

The microchip comprises a counter for keeping a track on a status of a swipe such as a good swipe or a bad swipe, a comparator for performing a frequency/double frequency (F2F) decoding and a post-processing of the swipe data to increase a probability of a good swipe, a converter for converting the swipe data into a card data, a memory unit for storing the card data, a tokenizer for converting the card data into a token data using a standard mathematical transformation, an encryption engine loaded with an encryption algorithm for encrypting the token data using a PKI (Public Key Infrastructure) asymmetric algorithm such as 1024 bit RSA algorithm, 2048 bit RSA algorithm, a modulation engine for modulating the token data, a low pass filter for filtering the token data, a voltage divider network for representing the token data as audio signal, a random number generator for avoiding replay attacks and an Analog to Digital Converter (ADC) for measuring a voltage level of the battery. The audio signal is an audio tone signal.

According to an embodiment herein, the information about the dongle includes at least one of a Global Universal Identification (GUID) associated with the dongle, a serial number of the dongle and a merchant's personal information provided at the time of registration.

According to an embodiment herein, the card is one of a magnetic card, a Near Field Communication (NFC) card, a smart card.

According to an embodiment herein, the computing device is one of a cell phone, an Apple's iPhone, an iPod, an iPad, an iTouch, a Google's Android device and a general purpose computer.

The client application provides a graphical user interface (GUI) for a user to interact with the system. The client application also includes a compression scheme for compressing the token data.

The dongle 101 is a tamperproof device and a circuit board in the dongle is impregnated with resin to provide a tamper proof property and a microprocessor based security fuse is provided in the dongle to provide a tamperproof property so that the security fuse is blown at a time of manufacturing the dongle.

The system 100 provides a user login based Virtual point of sales (POS) system. The virtual POS is provided by using different accounts in the computing device to act as different merchants.

The service provider is able to provide a Standard Development Kit (SDK) for a merchant to develop a client application. The merchant is able to develop the client application according to a requirement.

According to an embodiment herein, a camera of the computing device records a plurality of activities involved in the electronic transaction. As soon as dongle is connected to the computing device, the client application interfaces with the native camera applications and starts recording the plurality of actions.

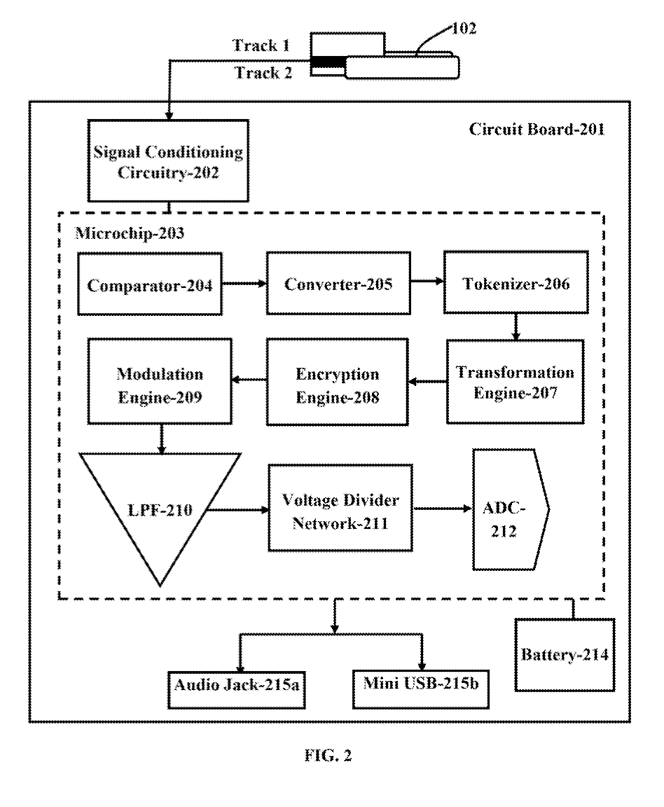

FIG. 2 illustrates a block circuit diagram of a dongle used in the system for secure electronic transaction, according to an embodiment herein. The components of the dongle 101 are integrated on a circuit board 201. The circuit board 201 comprises signal conditioning circuitry 202 and a microchip 203. The microchip 203 comprises a comparator 204 for performing a frequency/double frequency (F2F) decoding and a post-processing of the swipe data to increase a probability of a good swipe, a converter 205 for converting the swipe data into a card data, a tokenizer 206 for converting the card data into a token data using a standard mathematical transformation provided by a transformation engine 207, an encryption engine 208 loaded with an encryption algorithm for encrypting the token data using a Public Key Infrastructure (PKI) asymmetric algorithm such as 1024 bit RSA algorithm, 2048 bit RSA algorithm, a modulation engine 209 for modulating the token data, a low pass filter 210 for filtering the token data, a voltage divider network 211 for representing the token data as audio signal and an Analog to Digital Converter (ADC) 212 for measuring a voltage level of the battery. The audio signal is an audio tone signal.

According to an embodiment herein, the microchip 203 further comprises a counter for keeping a track on a status of a swipe such as a good swipe or a bad swipe.

According to an embodiment herein, the microchip 203 further comprises a memory unit (not shown in FIG. 2) for storing the card data.

According to an embodiment herein, the microchip 203 further comprises a random number generator for avoiding replay attacks.

The dongle 101 further comprises a magnetic card reader 213 for reading a swipe data, a battery 214 for a power supply and a retractable connecting plug. The swipe data is in the form of analog signals and is a unique data for the electronic card.

A retractable connecting plug connects the dongle 101 to the computing device through a connecting port such as audio jack 215a or a mini USB 215b. The swipe data is recorded at a first swipe.

The flash stores a dongle ID, a serial number of the dongle and a public key. The dongle ID and the serial number of the dongle are paired at a time of manufacturing the dongle. The dongle ID is a unique and secret ID associated with the dongle. The public key is used in RSA algorithm for encrypting the card data.

According to an embodiment herein, the dongle further includes a keypad for reading a PIN entered by the card holder.

The dongle 101 is powered by swiping a magnetic card, inserting a smart card, waving a NFC card. The power is produced by one of a micro-switch, a low power amplifier or a comparator, a switch in the audio jack, a sensitive microphone, a photo detector having a solar cell and a mic bias.

The dongle 101 is a tamperproof device and a circuit board in the dongle is impregnated with resin to provide a tamper proof property and a microprocessor based security fuse is provided in the dongle to provide a tamperproof property so that the security fuse is blown at a time of manufacturing the dongle.

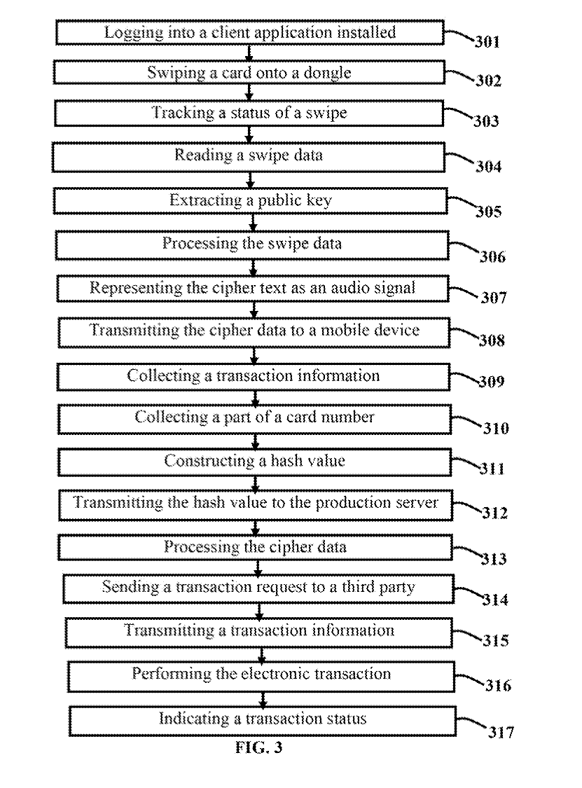

FIG. 3 illustrates a flowchart for a method for secure electronic transaction, according to an embodiment herein. The method comprising the steps of logging in by a merchant into a client application installed on a computing device (301), swiping a card onto a dongle (302), tracking a status of a swipe (303), reading a swipe data by a magnetic card reader of the dongle (304), extracting a public key burnt on a flash of the dongle (305), processing the swipe data by a microchip for producing a cipher data (306), representing the cipher data as an audio signal (307), transmitting the cipher data to a mobile device through an audio jack of the mobile device (308), collecting a transaction information through a graphical user interface (GUI) (309), collecting a part of a card number from the merchant (310), constructing a hash value out of the cipher data by using a hash algorithm of a client application running on a computing device (311), transmitting the hash value along with the transaction information to a production server through a first communication network (312), processing the cipher data in a payment server of the production server (313), sending a transaction request to a third party system to perform an electronic transaction (314), transmitting a transaction information to the third party system through a second communication network (315), performing the electronic transaction by the third party system (316) and indicating a transaction status (317). The GUI is provided by the client application.

The data communicated between the mobile device and the dongle is in a form of acoustic signals or audio tones.

The hash algorithm is exchanged and stored between the mobile device and the payment server for a first time;

The transaction status is indicated by an audio tone or a colored light. The transaction status is one of a bad transaction and a good transaction.

The step processing the swipe data by a microchip for producing a cipher data (306) comprises generating a random number for avoiding a replay attack, decoding the swipe data by a comparator, converting the swipe data into a card data by a converter, tokenization of the card data by a tokenizer by Xoring the card data with a dongle ID, encrypting the card data into a cipher data by an encryption engine using a RSA algorithm and modulating the cipher data by a modulation engine using Frequency Shift Keying (FSK). The dongle ID is a unique and secret ID related to the dongle.

According to an embodiment herein, a public key is used in RSA algorithm for encrypting the card data.

According to an embodiment herein, the step of processing the cipher data in a payment server of the production server (313) comprises decoding the hash value by a decoder of the payment server for producing the cipher data, decrypting the cipher data by a decryption engine of the payment server using a private key, retrieving a merchant information stored in a payment database of the production server, reproducing a complete card number by stitching a part of the card number entered by the merchant with a card data received from the dongle and authenticating the merchant.

According to an embodiment herein, the step of representing the cipher data as an audio signal (307) comprises filtering the cipher data by a low pass filter and dividing a voltage of cipher data for producing amplitude for the audio signal.

According to an embodiment herein, the step of constructing the hash value out of the encrypted data by the hash function of the client application running on the mobile phone (311) is done by creating a date/time stamp.

According to an embodiment herein, the method for secure electronic transaction further comprises sending an electronic receipt to the customer through a short message service (SMS) or an e-mail.

According to an embodiment here, the method for secure electronic transaction further comprises recording a transaction status by a counter of the microchip.

According to an embodiment herein, the method for secure electronic transaction further comprises measuring a voltage level of a battery of the dongle by an analog-to-digital convertor (ADC) of the microprocessor, sending a measured voltage level along with the transaction data to the production server, collating a reading of the battery by the payment server, computing a remaining voltage level in the battery by the payment server and sending an information corresponding to the remaining voltage level in the battery to a user. The information is sent to the user's mobile phone through a SMS or an Email.

According to an embodiment herein, the transaction information includes an amount of the transaction, a unique PIN of the card entered by the card holder, an additional data related to the transaction and a signature of a card holder.

According to an embodiment herein, the method for secure electronic transaction further comprises an updating of the public key. Updating of the public key comprises swiping a non financial card on a swipe machine, reading a swipe data by a reader head of the dongle, extracting a public key from the swipe data and updating the public key associated with the dongle.

According to an embodiment herein, the method for secure electronic transaction further comprises mapping a merchant ID, a terminal ID, a user ID, IMEI number of computing device, a serial number of the dongle with a dangle ID for executing a secure electronic transaction.

According to an embodiment herein, the method of electronic transaction further comprising the step of updating a merchant's server located at the merchant's place. As soon as card is swiped and transaction is successful for a particular order, the corresponding details of the order in the merchant's server are updated.

According to an embodiment herein, the method for secure electronic transaction further comprises recording location information of the electronic transaction. The client application interfaces with a native GPS device and detects the location of the electronic transaction.

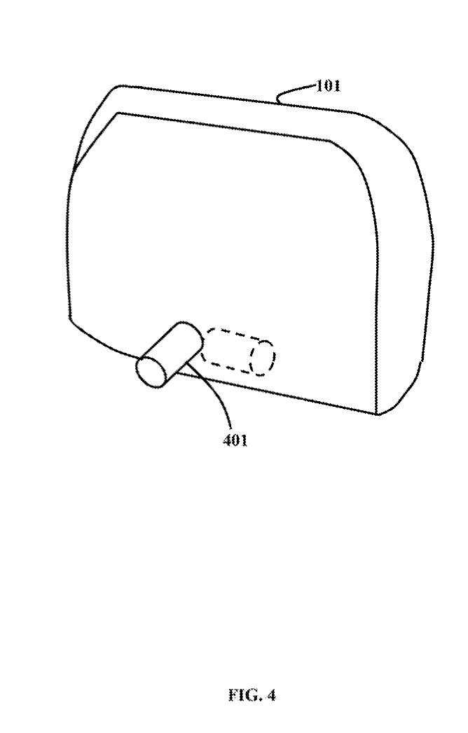

FIG. 4 illustrates a perspective view of a dongle used in a system for secure electronic transaction, according to an embodiment herein. As shown in FIG. 4, the dongle 101 comprises a retractable connecting plug 401. The retractable connecting plug 401 connects the dongle 101 to the computing device through a connecting port such as audio jack or a mini USB.

The embodiments herein provide a system and method for a secure electronic transaction. The system and method provides a way for a fast and an efficient electronic transaction. A portable swipe machine is provided for all the users wishing to do an electronic transaction.

The embodiments herein provide a cost effective swipe machine for a mobile device. A way to manage a power consumed by the system is provided. A compression scheme is provided for saving in the memory of the system. The embodiments herein provide a compression scheme that runs on an open device such as mobile device. The system provides a user interface for a mobile device to perform an electronic transaction. The random number generator prevents a replay attack in an electronic transaction.

The mobile device is provided with the scrambled keypad to safely enter a PIN on an open platform such as mobile, using a scrambled keypad method. The card data is transformed into a token data which is transmitted to a payment server through a mobile device thereby eliminating a need for transmitting a card data. The dongle is also is provided with a keypad for avoiding tampering with the keypad of the computing device. Using the keypad of the dongle, the customer can enter the PIN.

The user friendly SDK provided by the service provider is used by the merchant to develop a customized client application. A system integrates easily with the merchant's server for updating the status of an order after an electronic transaction.

The system and method provides a machine level encryption of a data for an electronic transaction. The non financial card provided periodically to the users of the dongle make sure that, the public key is updated periodically to provide security. The camera of the computing device records a plurality of activities involved in an electronic transaction. The recording data is stored for security purpose.

The GPS of the computing device record the location of an electronic transaction, so that the location data can be used at the time of disputes about the transaction.

The foregoing description of the specific embodiments herein will so fully reveal the general nature of the embodiments herein that others can, by applying current knowledge, readily modify and/or adapt for various applications such specific embodiments herein without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system for a secure electronic transaction comprising:
a dongle connected to a computing device for reading an electronic card data, wherein the dongle comprises a magnetic card reader for reading a swipe data, and wherein the swipe data is in the form of analog signals and is a unique data for the electronic card, a microchip for decoding, tokenizing, transforming, encrypting, modulating and representing a swipe data and a personal identification number (PIN) data as an audio signal, a flash for storing a dongle ID, a serial number of the dongle and a public key, and wherein the dongle ID and the serial number of the dongle are paired at a time of manufacturing the dongle, a battery for a power supply, and a retractable connecting plug, and wherein the retractable connecting plug connects the dongle to the computing device through a connecting port, and wherein the connecting port is at least one of an audio jack or a mini universal serial bus (USB);
a client application running on a client device for collecting a transaction information from a customer, and wherein the client application provides a scrambled keypad for preventing an onlooker from detecting a personal identification number (PIN) entered by the customer;
a service provider system connected to the computing device through a first communication network for transmitting the collected transaction information and the audio signal from the computing device to the service provider system, and wherein the first communication network is an internet protocol (IP) network;
a production server located at the service provider system for processing the received card data, and wherein the production server comprises a gateway server for interfacing the client application and the production server, and wherein the gateway server conducts an authentication, firewalling and load balancing operations, a payment database for storing an information about the dongle, an analytics database, and wherein the analytics database stores a metadata, a frequency of a plurality of swipes for the electronic card, a plurality of fraud patterns and a plurality of customer spend patterns, a payment server for processing the audio signal, and wherein the payment server comprises a decoder for decoding the audio signal, a decryption engine loaded with a decryption algorithm for converting a cipher text to a normal text using a private key, wherein the private key is generated randomly by the payment server using a global unique identification (GUID) number and wherein the GUID is generated at the payment server based on the paired dongle ID and the serial number of the dongle;
a second communication network for transmitting a processed card data from the production server to a payment system, and wherein the second communication network is an IP network; and
a payment gateway running on the payment system for interfacing with the service provider system, and wherein the payment gateway interfaces a plurality of financial institutions to complete a financial transaction, and wherein the payment system performs the financial transaction by authenticating the customer and a merchant.

2. The system of claim 1, wherein the microchip comprises:
a counter for keeping a track on a status of a swipe, wherein the status of the swipe is a good swipe or a bad swipe;
a comparator for performing a frequency/double frequency (F2F) decoding and a post-processing of the swipe data to increase a probability of a good swipe;
a converter for converting the swipe data into a card data;
a memory unit for storing the card data;
a tokenizer for converting the card data into a token data using a standard mathematical transformation;
an encryption engine loaded with an encryption algorithm for encrypting the token data using a Public Key Infrastructure (PKI) asymmetric algorithm, wherein the PKI asymmetric algorithm is any one of 1024 bit RSA algorithm, 2048 bit RSA algorithm;
a modulation engine for modulating the token data;
a low pass filter for filtering the token data;
a voltage divider network for representing the token data as audio signal, and wherein the audio signal is an audio tone signal;
a random number generator for avoiding replay attacks; and
an Analog to Digital Converter (ADC) for measuring a voltage level of the battery.

3. The system of claim 1, wherein the dongle ID is a unique and secret ID associated with the dongle.

4. The system of claim 1, wherein the public key is used in RSA algorithm for encrypting the card data.

5. The system of claim 1, wherein the information about the dongle includes at least one of a Global Universal Identification (GUID) associated with the dongle, a serial number of the dongle, and a merchant's personal information provided at the time of registration.

6. The system of claim 1, wherein the dongle further includes a keypad for reading a PIN entered by the card holder.

7. The system of claim 1, wherein the PIN data is any one of a scrambled PIN data or a PIN block or a onetime password.

8. The system of claim 1, wherein the card is one of a magnetic card, a Near Field Communication (NFC) card and a smart card.

9. The system of claim 1, wherein the computing device is one of a cell phone, an Apple's iPhone, an iPod, an iPad, an iTouch, a Google's Android device and a general purpose computer.

10. The system of claim 1, wherein the swipe data is recorded at a first swipe to avoid a replay attack.

11. The system of claim 1, wherein the swipe data is sent alone as an audio signal after tokenization and encryption.

12. The system of claim 1, wherein the dongle is powered by swiping a magnetic card, inserting a smart card, tapping a NFC card, wherein power is produced by one of a micro-switch, a low power amplifier or a comparator, a switch in the audio jack, a sensitive microphone, a photo detector having a solar cell and a mic bias.

13. The system of claim 1, wherein the transaction information includes an amount of the transaction, an unique PIN of the card entered by the card holder, an additional data related to the transaction, and a signature of a card holder.

14. The system of claim 1, wherein the client application provides a graphical user interface (GUI) for a user to interact with the system.

15. The system of claim 1, wherein the client application includes a compression scheme for compressing the token data.

16. The system of claim 1, wherein the dongle is a tamperproof device and wherein a circuit board in the dongle is impregnated with resin to provide a tamper proof property and a microprocessor based security fuse is provided in the dongle to provide a tamperproof property so that the security fuse is blown at a time of manufacturing the dongle.

17. The system of claim 1, the system provides a user login based virtual point of sales (POS) system, wherein the virtual POS is provided by using different accounts in the computing device to act as different merchants.

18. The system of claim 1, wherein the dongle further comprises a public key burned at a time of manufacture the dongle.

19. The system of claim 1, wherein the dongle generates a session key and a secret key at a beginning of the transaction, and wherein the secret key is used for authenticating the payment server, and wherein the session key and secret key are encrypted by the public key before sending to the payment server.

20. The system of claim 1, wherein the payment server further comprises a private key, and wherein the private key decrypts the secret key sent by the dongle and sends back the decrypted secret key to the dongle for mutually authenticating the dongle and the payment server.

21. The system according to claim 1, wherein the dongle is injected with a plurality of keys, and wherein the plurality of keys is a banking domain key and an acquirer key.

22. The system according to claim 1, wherein the server is provided with a plurality of keys, and wherein the plurality of keys is a banking domain key and an acquirer key.

23. The system according to claim 1, wherein the banking key or the acquirer key is selected based on a card issuer.

24. The system according to claim 1, wherein the banking key or the acquirer key is selected from the dongle based on business intelligence (BI) rule and wherein the BI rule is set on the dongle using a user interface on a mobile phone and wherein the BI rule is set on the dongle using a server.

25. The system according to claim 1, wherein a PIN is encrypted in the dongle selected using the session key.

26. The system according to claim 1, wherein the PIN is translated into a banking domain key using a secure device and wherein the secure device is HSM device.

27. The system according to claim 1, wherein the banking key or the acquirer key is selected from the server based on a BIN number or a business intelligence (BI) rule.

28. The system according to claim 1, wherein the BIN number or the BI rule is set on the dongle by a merchant using a user interface on a mobile phone and wherein the BIN number or the BI rule is set on the dongle by a merchant using a user interface on a portal.

29. The system of claim 1, wherein the dongle further comprises a NFC tag, and wherein the NFC tag of the dongle includes a unique ID and a physical unclonable function (PUF).

30. The system of claim 1, wherein the merchant device comprises a NFC tag, and wherein the NFC tag of the merchant device authenticates the dongle by verifying the unique ID of the dongle NFC tag.

31. A method for a secure electronic transaction comprising the steps of:
logging in by a merchant into a client application installed on a computing device;
swiping a card onto a dongle;
tracking a status of a swipe;
reading a swipe data by a magnetic card reader of the dongle;
extracting a public key burnt on a flash of the dongle;
processing the swipe data by a microchip for producing a cipher data;
representing the cipher data and a PIN data as an audio signal;
transmitting the cipher data and the PIN data to a mobile device through an audio jack of the mobile device, and wherein the data communicated between the mobile device and the dongle is in a form of acoustic signals or audio tones;
collecting a transaction information through a graphical user interface (GUI) and wherein the GUI is provided by the client application;
collecting a part of a card number from the merchant;
constructing a hash value out of the cipher data by using a hash algorithm of a client application running on a computing device and wherein the hash algorithm is exchanged and stored between the mobile device and the payment server for a first time;
transmitting the hash value along with the transaction information to a production server through a first communication network;
processing the cipher data and the PIN data in a payment server of the production server;
sending a transaction request to a third party system to perform an electronic transaction;
transmitting a transaction information to the third party system through a second communication network;
performing the electronic transaction by the third party system; and
indicating a transaction status and wherein the transaction status is indicated by an audio tone or a colored light, and wherein the transaction status is one of a bad transaction and a good transaction.

32. The method of claim 31, wherein the step processing the swipe data by a microchip for producing a cipher data comprises:
generating a random number for avoiding a replay attack;
decoding the swipe data by a comparator;
converting the swipe data into a card data by a converter;
tokenization of the card data by a tokenizer by Xoring the card data with a dongle ID;
encrypting the card data into a cipher data by an encryption engine using a RSA algorithm, and wherein a public key is used in RSA algorithm for encrypting the card data; and
modulating the cipher data by a modulation engine using Frequency Shift Keying (FSK);
wherein the dongle ID is a unique and secret ID related to the dongle.

33. The method of claim 31, wherein the step of processing the cipher data in a payment server of the production server comprises:
decoding the hash value by a decoder of the payment server for producing the cipher data;
decrypting the cipher data by a decryption engine of the payment server using a private key;
retrieving a merchant information stored in a payment database of the production server;
reproducing a complete card number by stitching a part of the card number entered by the merchant with a card data received from the dongle; and
authenticating the merchant.

34. The method of claim 31, wherein the step of representing the cipher data as an audio signal comprises:
filtering the cipher data by a low pass filter; and
dividing a voltage of cipher data for producing an amplitude for the audio signal.

35. The method of claim 31, wherein the step of constructing the hash value out of the encrypted data by the hash function of the client application running on the mobile phone is done by creating a date/time stamp.

36. The method of claim 31, wherein the method further comprises sending an electronic receipt to the customer through a short message service (SMS) or an e-mail.

37. The method of claim 31, wherein the method further comprises recording a transaction status by a counter of the microchip.

38. The method of claim 31, wherein the method further comprises:
measuring a voltage level of a battery of the dongle by an analog-to-digital convertor (ADC) of the microprocessor,
sending a measured voltage level along with the transaction data to the production server, collating a reading of the battery by the payment server,
computing a remaining voltage level in the battery by the payment server, and
sending an information corresponding to the remaining voltage level in the battery to a user.

39. The method of claim 31, wherein the transaction information includes an amount of the transaction, an unique PIN data of the card entered by the card holder, an additional data related to the transaction, and a signature of a card holder.

40. The method according to claim 31, wherein the unique PIN is data is any one of a scrambled PIN data or a PIN block or a onetime password.

41. The method of claim 31, wherein the method further comprises an updating of the public key, and wherein the updating of the public key comprises swiping a non financial card on a swipe machine, reading a swipe data by a reader head of the dongle, extracting a public key from the swipe data and updating the public key associated with the dongle.

42. The method according to claim 31 further comprises mapping a merchant ID, a terminal ID, a user ID, IMEI number of computing device, a serial number of the dongle with a dongle ID for executing a secure electronic transaction.

43. The method according to claim 31 further comprises mapping a dongle ID, serial number of dongle with IMEI number of a mobile phone for executing a secure electronic transaction.

44. The method according to claim 31, wherein the public key is burned in the dongle at a manufacturing time.

45. The method according to claim 31, wherein the dongle generates a session key and a secret key at a beginning of the transaction, and wherein the secret key is used for authenticating the payment server, and wherein the session key and secret key are encrypted by the public key and sent to the payment server.

46. The method according to claim 31, wherein the payment server further comprises a private key, and wherein the private key decrypts the secret key sent by the dongle and sends back the decrypted secret key to the dongle for mutually authenticating the dongle and the payment server.

47. The method according to claim 31, wherein a plurality of keys is injected in the dongle and wherein the plurality of keys is a banking domain key and an acquirer key.

48. The method according to claim 31, wherein a plurality of keys is provided with the server and wherein the plurality of keys is a banking domain key and an acquirer key.

49. The method according to claim 31, wherein the banking key or the acquirer key is selected based on a card issuer.

50. The method according to claim 31, wherein the banking key or the acquirer key is selected from the dongle based on a business intelligence (BI) rule and wherein the BI rule is set on the dongle using a user interface on a mobile phone and wherein the BI rule is set on the dongle using a server.

51. The method according to claim 31, wherein a PIN is encrypted in the dongle selected using the session key.

52. The method according to claim 31, wherein the PIN is translated into a banking domain key using a secure device and wherein the secure device is HSM device.

53. The method according to claim 31, wherein the banking key or the acquirer key is selected from the server based on a BIN number or business intelligence (BI) rule.

54. The method according to claim 31, wherein the BIN number or the BI rule is set on the dongle by a merchant using a user interface on a mobile phone and wherein the BIN number or the BI rule is set on the dongle by a merchant using a user interface on a portal.

55. The method according to claim 31, wherein the dongle further comprises a NFC tag, and wherein the NFC tag of the dongle includes a unique ID and a physical unclonable function (PUF).

56. The method according to claim 31, wherein the merchant device comprises a NFC tag, and wherein the NFC tag of the merchant device authenticates the dongle by verifying the unique ID of the dongle NFC tag.

57. The method according to claim 31, wherein a swipe data alone is sent as an audio signal after tokenization and encryption.

58. A method for providing a user friendly secure electronic transaction comprising the steps of:
providing a SDK (Standard Development Kit) for a merchant to develop a client application and wherein the client application is developed by the merchant according to a requirement;
installing the client application on a computing device; and
executing a plurality of electronic transactions using the computing device.

59. The method according to claim 58, wherein the step of executing the plurality of electronic transactions comprises:
logging in by a merchant into a client application installed on a computing device;
swiping a card onto a dongle;
tracking a status of a swipe;
reading a swipe data by a magnetic card reader of the dongle;
extracting a public key burnt on a flash of the dongle;
processing the swipe data by a microchip for producing a cipher data;
representing the cipher data as an audio signal;
transmitting the cipher data to a mobile device through an audio jack of the computing device, and wherein the cipher data transmitted between the computing device and the dongle is in a form of acoustic signals or audio tones;
collecting a transaction information through a graphical user interface (GUI) and wherein the GUI is provided by the client application;
collecting a part of a card number from the merchant;
constructing a hash value out of the cipher data by using a hash algorithm of a client application running on a computing device and wherein the hash algorithm is exchanged and stored between the mobile device and the payment server for a first time;
transmitting the hash value along with the transaction information to a production server through a first communication network;
processing the cipher data in a payment server of the production server;
sending a transaction request to a third party system to perform an electronic transaction;
transmitting a transaction information to the third party system through a second communication network;
performing the electronic transaction by the third party system; and
indicating a transaction status and wherein the transaction status is indicated by an audio tone or a colored light, and wherein the transaction status is one of a bad transaction and a good transaction.

60. The method of claim 58, wherein the step processing the swipe data by a microchip for producing a cipher data comprises:
generating a random number for avoiding a replay attack;
decoding the swipe data by a comparator;
converting the swipe data into a card data by a converter;
tokenization of the card data by a tokenizer by Xoring the card data with a dongle ID;
encrypting the card data into a cipher data by an encryption engine using a RSA algorithm, and wherein a public key is used in RSA algorithm for encrypting the card data; and
modulating the cipher data by a modulation engine using Frequency Shift Keying (FSK);
wherein the dongle ID is a unique and secret ID related to the dongle.

61. The method of claim 58, wherein the step of processing the cipher data in a payment server of the production server comprises:
decoding the hash value by a decoder of the payment server for producing the cipher data;
decrypting the cipher data by a decryption engine of the payment server using a private key;
retrieving a merchant information stored in a payment database of the production server;
reproducing a complete card number by stitching a part of the card number entered by the merchant with a card data received from the dongle; and
authenticating the merchant.

62. The method of claim 58, wherein the step of representing the cipher data as an audio signal comprises:
filtering the cipher data by a low pass filter; and
dividing a voltage of cipher data for producing an amplitude for the audio signal.

63. The method of claim 58, wherein the step of constructing the hash value out of the encrypted data by the hash function of the client application running on the mobile phone is done by creating a date/time stamp.

64. The method of claim 58, wherein the method further comprises sending an electronic receipt to the customer through a short message service (SMS) or an e-mail.

65. The method of claim 58, wherein the method further comprises recording a transaction status by a counter of the microchip.

66. The method of claim 58, wherein the method further comprises:
measuring a voltage level of a battery of the dongle by an analog-to-digital convertor (ADC) of the microprocessor;
sending a measured voltage level along with the transaction data to the production server, collating a reading of the battery by the payment server;
computing a remaining voltage level in the battery by the payment server; and
sending an information corresponding to the remaining voltage level in the battery to a user.

67. The method of claim 58, wherein the method further comprises sending a plurality of promotional offers for a customer after reaching a preset frequency of transactions from an electronic card.

68. The method of claim 58, wherein the transaction information includes an amount of the transaction, an unique PIN of the card entered by the card holder, an additional data related to the transaction, and a signature of a card holder.

69. The method according to claim 58, wherein the unique PIN is data is any one of a scrambled PIN data or a PIN block or a onetime password.

70. The method of claim 58, wherein the method further comprises an updating of the public key, and wherein the updating of the public key comprises swiping a non financial card on a swipe machine, reading a swipe data by a reader head of the dongle, extracting a public key from the swipe data and updating the public key associated with the dongle.
